(19) United States
(12) Patent Application Publication
(10) Pub. No.: US 2026/0300859 A1
(43) Pub. Date: Oct. 1, 2026

(54) ASSISTANCE SYSTEM, METHOD, AND PROGRAM

(71) Applicant: NEC Corporation, Tokyo (JP)

(72) Inventors: Shin NORIEDA, Tokyo (JP); Hisaya WAKAYAMA, Tokyo (JP); Kenichi TAKIGUCHI, Tokyo (JP); Chisho UEDA, Tokyo (JP); Yuto TSUKADA, Tokyo (JP)

(73) Assignee: NEC Corporation, Tokyo (JP)

(21) Appl. No.: 19/577,525

(22) Filed: Mar. 25, 2026

(30) Foreign Application Priority Data
Mar. 28, 2025 (JP) 2025-055005

(51) Int. Cl. G06Q 10/0631

(52) U.S. Cl. CPC G06Q 10/063114

(57) ABSTRACT

The assistance system includes a detection unit, a determination unit, and an assistance unit. The detection unit detects a work status of a worker who performs divided tasks obtained by dividing tasks of a target business. The determination unit determines, based on the detected work status, a mismatch content between the divided tasks and personal characteristics of the worker. The assistance unit assists work of the worker in performing the divided tasks according to the mismatch content.

### CROSS-REFERENCE TO RELATED APPLICATIONS

This application is based upon and claims the benefit of priority from the prior Japanese Patent Application No. 2025-055005, filed Mar. 28, 2025, the entire contents of which are incorporated herein by reference.

### BACKGROUND OF THE INVENTION

The present disclosure relates to an assistance system, an assistance method, and an assistance program that assist work in a business.

Various methods have been proposed to improve work efficiency by enabling a human and a device to cooperatively perform work. For example, Patent Literature 1 describes a method for improving work performed by a user at a workplace. In the method described in Patent Literature 1, based on work actual condition data, replaceable tasks that are replaced or assisted by introduction of a predetermined device are identified among a plurality of tasks indicated by the work actual condition data.

### Prior Art Documents

### Patent Literatures

Patent Literature 1 Japanese Patent Application Laid-Open No. 2023-91634

### SUMMARY OF THE INVENTION

In the method described in Patent Literature 1, replacement tasks are identified based on work actual condition data that indicates work time calculated based on staying time in respective areas. In other words, since replacement tasks are identified by focusing on work time, it is difficult to say that personal characteristics of a worker are taken into consideration. Even if work time is short, when a task does not conform to personal characteristics of a worker, various burdens on the worker are assumed. Therefore, it is preferable to assist work according to characteristics of the worker.

Accordingly, an example object of the present disclosure is to provide an assistance system, an assistance method, and an assistance program that can assist work according to characteristics of a worker.

An assistance system according to the present disclosure includes a detection unit configured to detect a work status of a worker who performs divided tasks obtained by dividing tasks of a target business, a determination unit configured to determine, based on the detected work status, a mismatch content between the divided tasks and personal characteristics of the worker, and an assistance unit configured to assist work of the worker in performing the divided tasks according to the mismatch content.

An assistance method according to the present disclosure includes detecting a work status of a worker who performs divided tasks obtained by dividing tasks of a target business, determining, based on the detected work status, a mismatch content between the divided tasks and personal characteristics of the worker, and assisting work of the worker in performing the divided tasks according to the mismatch content.

An assistance program according to the present disclosure causes a computer to execute a detection process of detecting a work status of a worker who performs divided tasks obtained by dividing tasks of a target business, a determination process of determining, based on the detected work status, a mismatch content between the divided tasks and personal characteristics of the worker, and an assistance process of assisting work of the worker in performing the divided tasks according to the mismatch content.

According to the present disclosure, work can be assisted according to characteristics of a worker.

### BRIEF DESCRIPTION OF DRAWINGS

FIG. 1. is an explanatory diagram illustrating a configuration example of an example embodiment of the assistance system according to the present disclosure.

FIG. 2. is a flowchart illustrating an operation example of the assistance system.

FIG. 3. is an explanatory diagram illustrating an example of an assistance method using the assistance system.

FIG. 4. is a block diagram illustrating an overview of the assistance system according to the present disclosure.

FIG. 5. is a schematic block diagram illustrating a configuration of a computer according to at least one example embodiment.

### DETAILED DESCRIPTION OF THE INVENTION

Hereinafter, example embodiments of the present disclosure will be described with reference to the drawings.

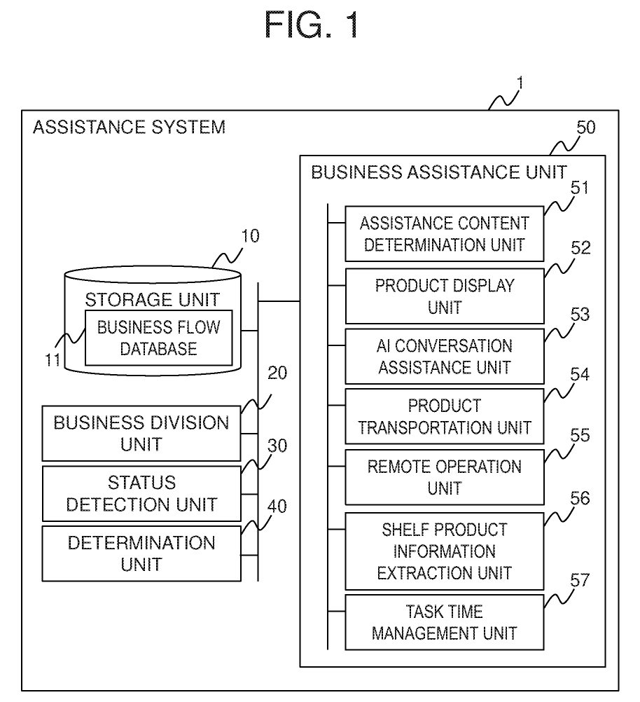

FIG. 1 is an explanatory diagram illustrating a configuration example of an example embodiment of an assistance system according to the present disclosure. An assistance system 1 according to the present example embodiment includes a storage unit 10, a business division unit 20, a status detection unit 30, a determination unit 40, and a business assistance unit 50.

The storage unit 10 stores various types of information used for processing by the assistance system 1. In the present example embodiment, the storage unit 10 includes a business flow database 11 that stores a business flow of a target business. A form of the business flow is arbitrary.

The business division unit 20 divides tasks included in the business flow stored in the storage unit 10. In the following description, divided tasks obtained by dividing tasks of the business may be referred to as divided tasks. Specifically, the business division unit 20 divides the business into tasks having a size that is not influenced by personal characteristics of a person, for example, a size that can be identified as a single action. For example, in a business of stocking goods in a store, the business may be divided into tasks such as inventory confirmation, unpacking, repackaging, cleaning up, information association, transportation, and display.

A method by which the business division unit 20 divides the business into tasks is arbitrary and is not limited to a specific method. For example, the business division unit 20 may divide the business into tasks according to an instruction of a user. The business division unit 20 may also divide the business into tasks based on a situation in which the business is performed.

For example, when dividing a business in which a blue-collar worker is engaged into tasks, the business division unit 20 may identify individual operations from video of a worker working at a factory or a construction site and divide the business into tasks for each identified operation. A known method may be used as a method for identifying operations from video.

For example, when dividing a business in which a white-collar worker is engaged into tasks, the business division unit 20 may identify individual operations from a processing flow of data input by the worker and divide the business into tasks for each identified operation. A known method may be used as a method for identifying operations from a processing flow of data.

The business division unit 20 may also cause a trained model, for example, an AI (Artificial Intelligence), to divide the business into individual tasks.

The status detection unit 30 detects a work status of a worker for each divided task. A method by which the status detection unit 30 detects the work status is determined according to a divided task to be detected and content to be detected.

For example, when detecting a work status relating to body movement of a worker who performs a task, the status detection unit 30 may collect video that indicates movement of the worker captured by a camera (not illustrated) and detect a work status of the divided task, for example, that an abnormality is observed in body movement.

For example, when detecting vital signs such as heart rate, respiration rate, and body temperature of a worker associated with performance of a task, the status detection unit 30 may measure vital signs of the worker detected by various sensors (not illustrated) and detect a work status of the divided task, for example, that a physical burden is imposed.

For example, when detecting a work time of a task, the status detection unit 30 may measure time using a timer (not illustrated) or measure a data processing time and detect a work status of the divided task, for example, that the task requires a long time.

For example, when detecting a work status relating to a conversation with a customer, the status detection unit 30 may collect audio that indicates a conversation status with the customer by using a microphone (not illustrated) attached to the worker and detect a work status of the divided task, for example, that the worker is having difficulty in conversation with the customer.

For example, when detecting overhead associated with assignment of a worker to a divided task, the status detection unit 30 may measure time until a start of work and detect a work status of the divided task, for example, a ratio of substantial work time.

Methods for collecting body movement from video, measuring vital signs by various sensors, collecting audio, and measuring work time are widely known, and therefore detailed description thereof is omitted.

The determination unit 40 determines, based on the detected work status, a mismatch content between the divided tasks and personal characteristics of the worker. A criterion for determining whether the divided tasks and the personal characteristics of the worker are mismatched is defined in advance. For example, a method for determining the mismatch content with respect to the detected work status may be stored in advance in the storage unit 10.

In the present example embodiment, the personal characteristics of the worker refer to characteristics that are taken into consideration when the worker performs tasks and specifically mean features or attributes formed by personality, ability, or the like of the individual. Examples of the personal characteristics of the worker include proficiency or non-proficiency in a task.

For example, the determination unit 40 may analyze captured video. When an analysis result that indicates that an abnormality is observed in movement of the worker (for example, that lower back pain is suspected from a walking posture of a store clerk) is obtained, the determination unit 40 may determine a mismatch content that indicates that the task does not conform to the personal characteristics, more specifically, that movement of goods imposes a burden or that heavy objects cannot be lifted.

For example, the determination unit 40 may analyze measured vital signs. When vital signs that exceed a reference value are detected, the determination unit 40 may determine a mismatch content that indicates that the task does not conform to the personal characteristics, more specifically, that a physical burden is imposed.

For example, the determination unit 40 may analyze collected audio. When an analysis result that indicates that the worker is having difficulty in conversation with a dialogue partner, for example, a customer, is obtained, the determination unit 40 may determine a mismatch content that indicates that the task does not conform to the personal characteristics, more specifically, that the worker is not good at communication or lacks product knowledge. In this case, the determination unit 40 may cause a trained model, for example, an AI that analyzes audio, to execute analysis processing.

For example, the determination unit 40 may determine a timing for starting assistance by using, as a trigger, that a store clerk is spoken to by a customer and determining that the clerk is not comfortable with communication. When an analysis result that indicates that communication is difficult is obtained from a response of the store clerk, the determination unit 40 may determine that subsequent responses are to be handled by AI.

For example, when it is detected that work time of a task exceeds an assumed reference time, the determination unit 40 may determine a mismatch content that indicates that the task does not conform to the personal characteristics, more specifically, that the task includes operations in which the worker is not proficient.

When it is determined that the divided tasks and the personal characteristics of the worker are mismatched, it is determined that a state in which assistance is required exists.

Further, the determination unit 40 may determine an appropriateness degree of assignment of the worker to the divided tasks in relation to the business flow. For example, when a worker who performs the divided tasks is changed frequently, it is assumed that significant overhead associated with the change occurs. Therefore, the determination unit 40 may determine whether the assignment is appropriate, that is, an appropriateness degree, according to work cost associated with assignment of the worker to the divided tasks, for example, overhead.

As a method for determining the appropriateness degree in relation to the business flow, the determination unit 40 may determine the appropriateness degree according to a magnitude of a ratio of overhead to work time assumed in the business flow.

The business assistance unit 50 operates to assist work of the worker who performs the divided tasks according to the mismatch content determined by the determination unit 40. The business assistance unit 50 includes an assistance content determination unit 51, a product display unit 52, an AI conversation assistance unit 53, a product transportation unit 54, a remote operation unit 55, a shelf product information extraction unit 56, and a task time management unit 57.

The assistance content determination unit 51 determines assistance content for assisting the worker according to the mismatch content and analysis result determined by the determination unit 40. The assistance content determination unit 51 executes processing according to the determined assistance content. The assistance content is arbitrary. For example, a robot or the like may assist all of the divided tasks determined to require assistance, or a robot or the like may assist only part of the divided tasks, that is, a human and a robot may cooperate.

In the present example embodiment, the assistance content determination unit 51 controls functions that assist work according to the determined assistance content, specifically, processing by the product display unit 52, the AI conversation assistance unit 53, the product transportation unit 54, the remote operation unit 55, the shelf product information extraction unit 56, and the task time management unit 57.

An overview of functions included in the business assistance unit 50, except for the assistance content determination unit 51, will be described. The product display unit 52 controls a robot that performs product display. The AI conversation assistance unit 53 assists conversation of the worker by using AI. The product transportation unit 54 controls a robot that performs product delivery. The remote operation unit 55 controls various robots by remote operation. The shelf product information extraction unit 56 extracts information of a designated product shelf from the storage unit 10. The task time management unit 57 manages time in which the worker performs various tasks.

For example, when the product display unit 52 guides a location of a product by conversation, it is effective when a worker cannot remember a location of the product. Further, when the product transportation unit 54 assists transportation to a front of a shelf by a robot or replenishes products by a robot, it is effective when the worker cannot carry or lift heavy objects, for example, when the worker has lower back pain and cannot carry heavy objects. Further, when the remote operation unit 55 performs work by remote operation of a robot, it is effective when commuting requires a long time, for example, when a distance from a residence to a workplace is long. Further, when the AI conversation assistance unit 53 handles conversation with a customer, it is effective when the worker is not good at communication and cannot provide product guidance. Further, when the task time management unit 57 manages finely divided task times, it is effective for time adjustment when a worker cannot secure a continuous block of time due to childcare or caregiving.

In the present example embodiment, functions realized by the product display unit 52, the AI conversation assistance unit 53, the product transportation unit 54, the remote operation unit 55, the shelf product information extraction unit 56, and the task time management unit 57 are exemplified as functions that assist work. However, functions that assist work are not limited to those realized by these configurations. The business assistance unit 50 may include part of these configurations, a plurality of these configurations, or other configurations.

For example, when physical assistance is required, the assistance content determination unit 51 may control a device that assists movement of the worker according to the mismatch content and analysis result. For example, when informational assistance is required, the assistance content determination unit 51 may control a function that transmits necessary information according to the mismatch content and analysis result.

For example, when an analysis result that indicates that an abnormality is observed in movement of the worker is derived, the assistance content determination unit 51 may control a device that assists movement of the worker, for example, a device that realizes the product display unit 52, the product transportation unit 54, or the remote operation unit 55, according to the analysis result.

For example, when it is determined as a result of analyzing conversation content that the worker is having difficulty and an analysis result that indicates that the worker is having difficulty in conversation with a dialogue partner is derived, the assistance content determination unit 51 may control a device that realizes the AI conversation assistance unit 53 or the shelf product information extraction unit 56 so as to transmit information that assists conversation to a terminal carried by the worker according to the analysis result.

For example, when an analysis result that indicates that the worker is having difficulty in conversation with a dialogue partner is derived, the assistance content determination unit 51 may control a device that realizes the AI conversation assistance unit 53 or the shelf product information extraction unit 56 so as to transmit information that assists conversation to a terminal carried by the worker according to the analysis result.

Further, the assistance content determination unit 51 may optimize assignment of the worker according to the appropriateness degree of assignment of the worker to the divided tasks. A method for optimizing assignment of the worker is widely known, and therefore detailed description thereof is omitted.

The business division unit 20, the status detection unit 30, the determination unit 40, and the business assistance unit 50 (specifically, the assistance content determination unit 51) are implemented by a processor of a computer that operates according to a program, for example, a CPU (Central Processing Unit). For example, the program is stored in the storage unit 10 of the assistance system 1, and the processor reads the program and operates as the business division unit 20, the status detection unit 30, the determination unit 40, and the business assistance unit 50 (specifically, the assistance content determination unit 51) in accordance with the program. Functions of the assistance system 1 may also be provided in a SaaS (Software as a Service) format.

The business division unit 20, the status detection unit 30, the determination unit 40, and the business assistance unit 50 (specifically, the assistance content determination unit 51) may each be implemented by dedicated hardware. Some or all components of each device may be implemented by general-purpose or dedicated circuitry, a processor, or a combination thereof. These may be configured by a single chip or by a plurality of chips connected via a bus. Some or all components of each device may be implemented by a combination of the circuitry described above and a program.

When some or all components of the assistance system 1 are implemented by a plurality of information processing apparatuses or circuitry, the plurality of information processing apparatuses or circuitry may be arranged in a centralized manner or in a distributed manner. For example, the information processing apparatuses or circuitry may be implemented in a form in which they are connected via a communication network, such as a client-server system or a cloud computing system.

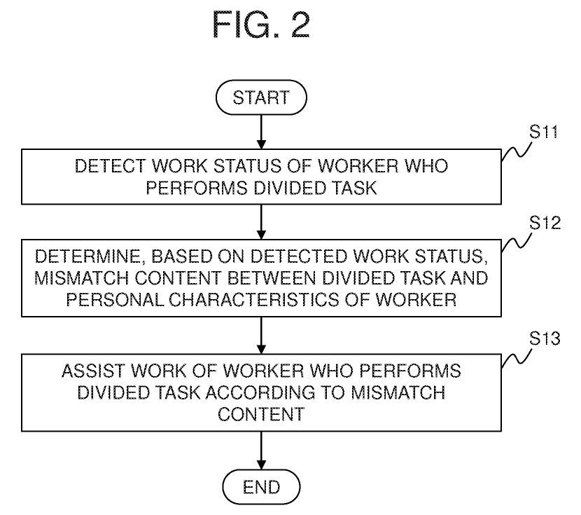

Next, an operation example of the assistance system 1 according to the present example embodiment will be described. FIG. 2 is a flowchart illustrating an operation example of the assistance system 1. The status detection unit 30 detects a work status of a worker who performs divided tasks (Step S11). The determination unit 40 determines, based on the detected work status, a mismatch content between the divided tasks and personal characteristics of the worker (Step S12). The business assistance unit 50 assists work of the worker who performs the divided tasks according to the mismatch content (Step S13).

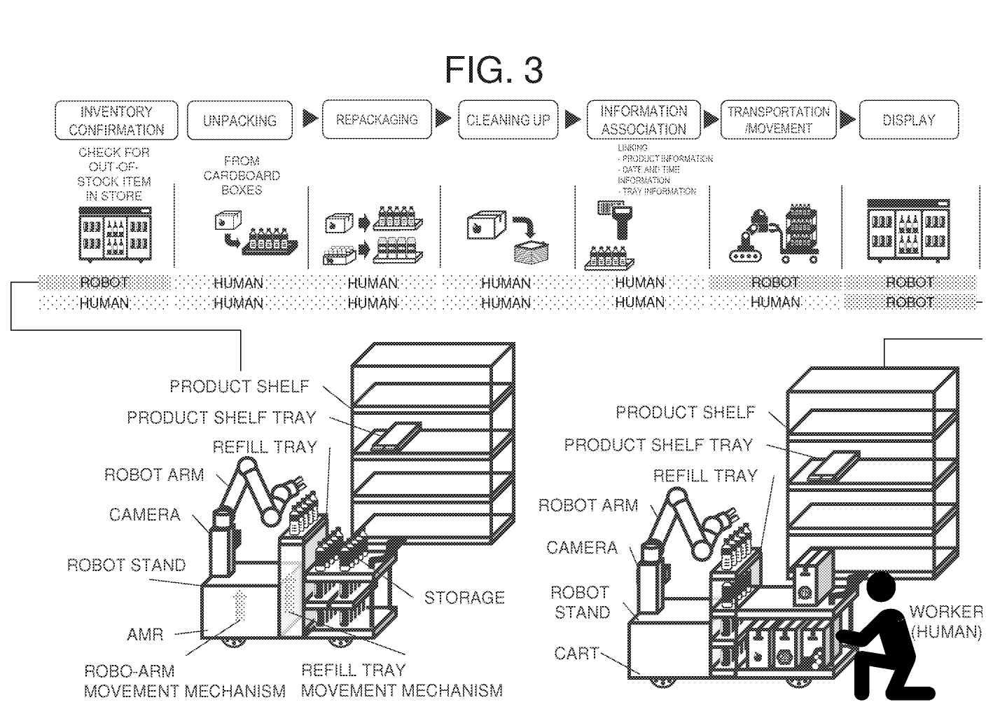

Next, a specific assistance method using the assistance system 1 according to the present example embodiment will be described. FIG. 3 is an explanatory diagram illustrating an example of an assistance method using the assistance system 1. In the specific example illustrated in FIG. 3, business analysis is performed in a retail store operation, tasks are divided, and assistance is provided by an AI robot. As a result of the business analysis, the business is divided into tasks such as inventory confirmation (checking for out-of-stock items in stores), unpacking from cardboard boxes, repackaging, cleaning up, information association, transportation or movement, and display.

In the example illustrated in FIG. 3, it is determined that the divided tasks of inventory confirmation and transportation or movement are to be performed cooperatively by a robot and a human, and that the divided task of display is to be performed solely by a robot.

The status detection unit 30 detects a work status of a worker who performs the divided tasks, the determination unit 40 determines, based on the detected work status, a mismatch content between the divided tasks and personal characteristics of the worker, and the business assistance unit 50 assists work of the worker according to the mismatch content. Accordingly, work can be assisted according to characteristics of the worker.

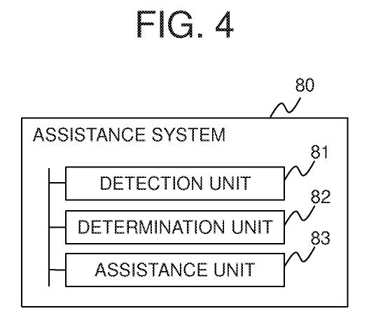

Next, an overview of the present disclosure will be described. FIG. 4 is a block diagram illustrating an overview of an assistance system according to the present disclosure. An assistance system 80 (for example, the assistance system 1) includes a detection unit 81 (for example, the status detection unit 30) configured to detect a work status of a worker who performs divided tasks obtained by dividing tasks of a target business, a determination unit 82 (for example, the determination unit 40) configured to determine, based on the detected work status, a mismatch content between the divided tasks and personal characteristics of the worker, and an assistance unit 83 (for example, the business assistance unit 50) configured to assist work of the worker in performing the divided tasks according to the mismatch content.

With such a configuration, work can be assisted according to characteristics of the worker.

The assistance unit 83 (for example, the assistance content determination unit 51) may determine assistance content for assisting the worker according to the mismatch content and may execute processing according to the determined assistance content.

The detection unit 81 may detect the work status of the divided tasks by collecting video that indicates movements of the worker captured by a camera, and the determination unit 82 may analyze the captured video and determine the mismatch content between the divided tasks and the personal characteristics of the worker.

Specifically, the determination unit 82 may analyze the video and derive an analysis result that indicates that an abnormality is observed in movements of the worker, and the assistance unit 83 may control a device that assists movements of the worker according to the analysis result.

The detection unit 81 may detect the work status of the divided tasks by collecting audio that indicates a conversation status of the worker, and the determination unit 82 may analyze the collected audio and determine the mismatch content between the divided tasks and the personal characteristics of the worker.

Specifically, the determination unit 82 may analyze the collected audio and derive an analysis result that indicates that the worker is having difficulty in conversation with a dialogue partner, and the assistance unit 83 may transmit information that assists the conversation to a terminal carried by the worker according to the analysis result.

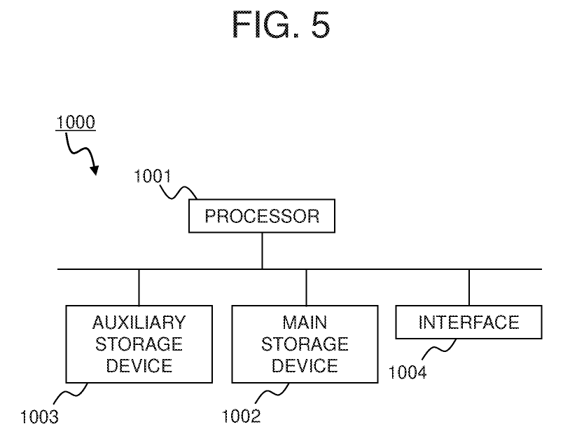

FIG. 5 is a schematic block diagram illustrating a configuration of a computer according to at least one example embodiment. A computer 1000 includes a processor 1001, a main storage device 1002, an auxiliary storage device 1003, and an interface 1004. A computer that executes a mathematical programming solver, an annealing machine, a simulator, or the like may be connected to the computer 1000.

The assistance system 80 described above is implemented in the computer 1000. Operations of the respective processing units described above are stored in the auxiliary storage device 1003 in the form of a program (assistance program). The processor 1001 reads the program from the auxiliary storage device 1003 into the main storage device 1002 and executes processing according to the program.

In at least one example embodiment, the auxiliary storage device 1003 is an example of a non-transitory tangible medium. Other examples of the non-transitory tangible medium include a magnetic disk, a magneto-optical disk, a CD-ROM, a DVD-ROM, and a semiconductor memory connected via the interface 1004. When the program is distributed to the computer 1000 via a communication line, the computer 1000 that receives the distribution may expand the program into the main storage device 1002 and execute the processing described above.

The program may implement part of the functions described above. The program may also be a so-called differential file that implements the functions described above in combination with another program that is already stored in the auxiliary storage device 1003.

Some or all of the example embodiments described above may also be described as follows, but are not limited thereto.

(Supplementary Note 1) An assistance system comprising: a detection unit configured to detect a work status of a worker who performs divided tasks obtained by dividing tasks of a target business; a determination unit configured to determine, based on the detected work status, a mismatch content between the divided tasks and personal characteristics of the worker; and an assistance unit configured to assist work of the worker in performing the divided tasks according to the mismatch content.

(Supplementary Note 2) The assistance system according to Supplementary Note 1, wherein the assistance unit is configured to determine assistance content for assisting the worker according to the mismatch content and to execute processing according to the determined assistance content.

(Supplementary Note 3) The assistance system according to Supplementary Note 1 or 2, wherein the detection unit is configured to detect the work status of the divided tasks by collecting video that indicates movements of the worker captured by a camera, and wherein the determination unit is configured to analyze the captured video and determine the mismatch content between the divided tasks and the personal characteristics of the worker.

(Supplementary Note 4) The assistance system according to Supplementary Note 3, wherein the determination unit is configured to analyze the video and derive an analysis result that indicates that an abnormality is observed in movements of the worker, and wherein the assistance unit is configured to control a device that assists movements of the worker according to the analysis result.

(Supplementary Note 5) The assistance system according to Supplementary Note 1 or 2, wherein the detection unit is configured to detect the work status of the divided tasks by collecting audio that indicates a conversation status of the worker, and wherein the determination unit is configured to analyze the collected audio and determine the mismatch content between the divided tasks and the personal characteristics of the worker.

(Supplementary Note 6) The assistance system according to Supplementary Note 5, wherein the determination unit is configured to analyze the collected audio and derive an analysis result that indicates that the worker is having difficulty in conversation with a dialogue partner, and wherein the assistance unit is configured to transmit information that assists the conversation to a terminal carried by the worker according to the analysis result.

(Supplementary Note 7) The assistance system according to Supplementary Note 1 or 2, wherein the detection unit is configured to detect a work cost associated with assignment of a worker to divided tasks, the determination unit is configured to determine an appropriateness degree of assignment of the worker to the divided tasks in relation to a business flow, and the assistance unit is configured to optimize assignment of the worker according to the appropriateness degree.

(Supplementary Note 8) The assistance system according to Supplementary Note 1 or 2, further comprising a business division unit configured to generate divided tasks obtained by dividing tasks included in a business flow.

(Supplementary Note 9) An assistance method comprising: detecting a work status of a worker who performs divided tasks obtained by dividing tasks of a target business; determining, based on the detected work status, a mismatch content between the divided tasks and personal characteristics of the worker; and assisting work of the worker in performing the divided tasks according to the mismatch content.

(Supplementary Note 10) The assistance method according to Supplementary Note 9, comprising: determining assistance content for assisting the worker according to the mismatch content; and executing processing according to the determined assistance content.

(Supplementary Note 11) A non-transitory computer-readable medium storing an assistance program for causing a computer to execute: a detection process of detecting a work status of a worker who performs divided tasks obtained by dividing tasks of a target business; a determination process of determining, based on the detected work status, a mismatch content between the divided tasks and personal characteristics of the worker; and an assistance process of assisting work of the worker in performing the divided tasks according to the mismatch content.

(Supplementary Note 12) The non-transitory computer-readable medium according to Supplementary Note 11, further causing the computer to execute: in the assistance process, a determination process of determining assistance content for assisting the worker according to the mismatch content; and an execution process of executing processing according to the determined assistance content.

Although the invention has been described above with reference to example embodiments and examples, the invention is not limited to the above example embodiments and examples. Various modifications that can be understood by those skilled in the art may be made within the scope of the invention.

1. An assistance system comprising:
a memory storing instructions; and
one or more processors configured to execute the instructions to:
detect a work status of a worker who performs divided tasks obtained by dividing tasks of a target business;
determine, based on the detected work status, a mismatch content between the divided tasks and personal characteristics of the worker; and
assist work of the worker in performing the divided tasks according to the mismatch content.

2. The assistance system according to claim 1,
wherein the processor is configured to execute the instructions to determine assistance content for assisting the worker according to the mismatch content and execute processing according to the determined assistance content.

3. The assistance system according to claim 1, wherein the processor is configured to execute the instructions to:
detect the work status of the divided tasks by collecting video that indicates movements of the worker captured by a camera; and
analyze the captured video and determine the mismatch content between the divided tasks and the personal characteristics of the worker.

4. The assistance system according to claim 3, wherein the processor is configured to execute the instructions to:
analyze the video and derive an analysis result that indicates that an abnormality is observed in movements of the worker; and
control a device that assists movements of the worker according to the analysis result.

5. The assistance system according to claim 1, wherein the processor is configured to execute the instructions to:
detect the work status of the divided tasks by collecting audio that indicates a conversation status of the worker; and
analyze the collected audio and determine the mismatch content between the divided tasks and the personal characteristics of the worker.

6. The assistance system according to claim 5, wherein the processor is configured to execute the instructions to:
analyze the collected audio and derive an analysis result that indicates that the worker is having difficulty in conversation with a dialogue partner, and
transmit information that assists the conversation to a terminal carried by the worker according to the analysis result.

7. An assistance method comprising:
detecting a work status of a worker who performs divided tasks obtained by dividing tasks of a target business;
determining, based on the detected work status, a mismatch content between the divided tasks and personal characteristics of the worker; and
assisting work of the worker in performing the divided tasks according to the mismatch content.

8. The assistance method according to claim 7, comprising:
determining assistance content for assisting the worker according to the mismatch content; and
executing processing according to the determined assistance content.

9. A non-transitory computer readable information recording medium storing an assistance program, when executed by a processor, that performs a method for:
detecting a work status of a worker who performs divided tasks obtained by dividing tasks of a target business;
determining, based on the detected work status, a mismatch content between the divided tasks and personal characteristics of the worker; and
assisting work of the worker in performing the divided tasks according to the mismatch content.

10. The non-transitory computer-readable medium according to claim 9, wherein the assistance program performs a method for:
determining assistance content for assisting the worker according to the mismatch content; and
executing processing according to the determined assistance content.
